(19) United States
(12) Patent Application Publication
(10) Pub. No.: US 2014/0332716 A1
(43) Pub. Date: Nov. 13, 2014

(54) ANODE ACTIVE MATERIAL FOR SECONDARY BATTERY, AND SECONDARY BATTERY INCLUDING SAME

(71) Applicant: MK Electron Co., Ltd., Gyeonggi-do (KR)

(72) Inventors: Soon Ho HONG, Gyeonggi-do (KR); Jong Soo CHO, Seoul (KR); Jeong Tak Moon, Gyeonggi-do (KR)

(21) Appl. No.: 14/340,897

(22) Filed: Jul. 25, 2014

Related U.S. Application Data
(63) Continuation of application No. PCT/KR2012/010151, filed on Nov. 28, 2012.

(30) Foreign Application Priority Data
Jan. 31, 2012 (KR) 10-2012-0009745

(51) Int. Cl. H01M 4/38; H01M 10/052

(52) U.S. Cl. CPC H01M 4/386; H01M 10/052
USPC 252/182.1

(57) ABSTRACT

An anode active material for a secondary battery includes an amount of a first element group in a range of about 0 at % (atomic percent) to about 30 at %, an amount of a second element group in a range of about 0 at % to about 20 at %, a balance of silicon and other unavoidable impurities. The first element group may include copper (Cu), iron (Fe), or a mixture thereof, and the second element group may include titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P) or mixtures thereof.

### CROSS REFERENCE TO RELATED APPLICATIONS

This application is a continuation of Patent Cooperation Treaty (PCT) international application Serial No. PCT/KR2012/010151, filed on Nov. 28, 2012 and which designates the United States and claims priority to Korean Patent Application No. 10-2012-0009745, filed on Jan. 31, 2012. The entirety of both Patent Cooperation Treaty (PCT) international application Serial No. PCT/KR2012/010151 and Korean Patent Application No. 10-2012-0009745 are hereby incorporated by reference herein.

### FIELD OF THE INVENTION

The present invention relates to secondary batteries, and more particularly, to anode active materials for secondary batteries that are capable of providing charging and discharging characteristics having high capacity and high efficiency, and secondary batteries including the same.

### BACKGROUND

Recently, application fields of lithium secondary batteries have been rapidly expanding. That is, lithium secondary batteries have been used not only as power sources for portable electronic products including cellular phones and notebook computers, but also as medium and large sized power sources for hybrid electronic vehicles (HEVs) and plug-in HEVs. According to such an expansion of the application field and an increase in demands, external shapes and sizes of batteries have also been diversely varied, and capacity, lifetime and safety that are more excellent than characteristics required in conventional small batteries are required in the batteries.

In general, materials enabling intercalation and deintercalation of lithium ions are used as anodes and cathodes, porous separators are located between the anodes and cathodes, and electrolytes are injected to manufacture lithium secondary batteries. Electricity is generated or consumed by oxidation and reduction reactions due to intercalation and deintercalation of lithium ions in the anodes and cathodes.

Graphite, an anode active material that is widely used in previous lithium secondary batteries, has characteristics that are very useful in intercalation and deintercalation of lithium ions since it has a layered structure. Although graphite exhibits a theoretical capacity of about 372 mAh/g, an electrode that can replace graphite is desirable as a demand for high capacity lithium batteries has recently increased. Accordingly, research is actively being conducted for commercializing electrode active materials for forming electrochemical alloys together with lithium ions, including silicon (Si), tin (Sn), antimony (Sb) and aluminum (Al) as high capacity anode active materials. However, elements such as silicon, tin, antimony, aluminum have characteristics in which volumes of the elements are increased or decreased during charging or discharging by forming the electrochemical alloys with lithium. Changes in the volumes of the elements according to such charging and discharging deteriorates the electrode cycle characteristics in electrodes to which active materials such as silicon, tin, antimony, and aluminum are introduced. Further, such changes in the volumes of the elements cause cracks to form in surfaces of electrode active materials. Consistent formation of cracks may generate fine particles on the electrode surfaces, resulting in the deterioration of cycle characteristics of the batteries.

### SUMMARY

Anode active materials for secondary batteries provide charging and discharging characteristics having high capacity and high efficiency. Furthermore, anode active materials for the secondary batteries are provided.

According to one aspect, an anode active material for a secondary battery includes an amount of a first element group in a range of about 0 at % (atomic percent) to about 30 at %, an amount of a second element group in a range of about 0 at % to about 20 at %, and an amount of silicon and other unavoidable impurities. The first element group comprises copper (Cu), iron (Fe), or a mixture thereof, and the second element group comprises at least one element selected from the group consisting of titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), and mixtures thereof.

In one embodiment, the amount of silicon is in a range of about 60 at % to about 85 at %.

In one embodiment, the amount of silicon is in a range of about 70 at % to about 85 at %.

In one embodiment, the first element group comprises both copper and iron, where the amount of the copper is in a range of about 0 at % to about 15 at %, and the amount of iron is in a range of about 0 at % to about 15 at %.

In one embodiment, the amount of iron to the amount of copper is in a ratio of about 1 to about 1.

In one embodiment, the amount of the second element group is in a range of about 0 at % to about 10 at %.

In one embodiment, the second element group comprise both titanium and nickel. The amount of titanium is in a range of about 0 at % to about 10 at %, and the amount of nickel is in a range of about 0 at % to about 10 at %.

In one embodiment, the first element group comprises both copper and iron, and the second element group excludes nickel and titanium, and the amount of silicon is in a range of about 60 at % to about 85 at %.

In one embodiment, the anode active manufacturing comprises about 18 at % to 20 at % of the first element group, where the first element group comprises equal amounts of copper and iron, and about 5 at % to about 7 at % of the second element group, where the second element group is made up of a single element.

According to another aspect, a second battery including an anode active material for a secondary battery is provided, where the anode active material comprises an amount of a first element group in a range of about 0 at % to about 30 at %, an amount of a second element group in a range of about 0 at % to about 20 at %, and an amount of silicon and other unavoidable impurities. The first element group comprises copper (Cu), iron (Fe), or a mixture thereof, where the second element group comprises at least one element selected from the group consisting of titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), and mixtures thereof, and the anode active material comprises a silicon single phase and a silicon-metal alloy phase distributed around the silicon single phase.

In one embodiment, an anode active material for a secondary battery may comprise an amount of a first element group in a range of about 0 at % to about 30 at %, an amount of a second element group in a range of about 0 at % to about 20 at %, and an amount of silicon and other unavoidable impurities. The first element group comprises copper (Cu), iron (Fe), or a mixture thereof, and the second element group comprises at least one element selected from the group consisting of titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), and mixtures thereof.

The anode active material is excellent in initial discharge capacity and cycle characteristics although the anode active material has a high content of silicon and low contents of nickel and titanium. Since contents of expensive nickel and titanium can be reduced accordingly, an anode active material for a secondary battery having excellent electrochemical performance and economic efficiency is provided.

### BRIEF DESCRIPTION OF THE DRAWINGS

FIG. 1 is a schematic diagram illustrating a secondary battery according to one embodiment;

FIG. 2 is a schematic diagram of an anode in the secondary battery of FIG. 1;

FIG. 3 is a schematic diagram of a cathode in the secondary battery of FIG. 1;

FIG. 4 is a flow chart illustrating a method of preparing an anode active material included in an anode of a secondary battery according to an embodiment;

FIG. 5 is a schematic diagram illustrating a method of forming an anode active material according to an embodiment;

FIG. 6 is a table comparing the composition ratios in the Examples;

FIG. 7A is a graph illustrating initial discharge capacity of the anode active materials prepared in Examples 1-2, Examples 14-16, and the Comparative Example shown in FIG. 6;

FIG. 7B is a graph illustrating initial coulombic efficiency of the anode active materials prepared in Examples 1-2, Examples 14-16, and the Comparative Example shown in FIG. 6;

FIG. 7C is a graph illustrating capacity retention rate of the anode active materials prepared in Examples 1-2, Examples 14-16, and the Comparative Example shown in FIG. 6;

FIG. 8A is a graph illustrating initial discharge capacity of the anode active materials prepared in Examples 1-13 and the Comparative Example shown in FIG. 6;

FIG. 8B is a graph illustrating initial coulombic efficiency of the anode active materials prepared in Examples 1-13 and the Comparative Example shown in FIG. 6;

FIG. 8C is a graph illustrating capacity retention rate of the anode active materials prepared in Examples 1-13 and the Comparative Example shown in FIG. 6;

FIG. 9A is a graph illustrating initial discharge capacity of the anode active materials prepared in Examples 14-27 and the Comparative Example shown in FIG. 6;

FIG. 9B is a graph illustrating initial coulombic efficiency of the anode active materials prepared in Examples 14-27 and the Comparative Example shown in FIG. 6;

FIG. 9C is a graph illustrating capacity retention rate of the anode active materials prepared in Examples 14-27 and the Comparative Example shown in FIG. 6;

FIG. 10A is a graph illustrating initial discharge capacity of the anode active materials prepared in Ti, Mn, Al, Cr, Co, Zn, B, Be, Mo, Ta, Na, Sr, and P;

FIG. 10B is a graph illustrating capacity retention rate of the anode active materials prepared in Ti, Mn, Al, Cr, Co, Zn, B, Be, Mo, Ta, Na, Sr, and P;

### DETAILED DESCRIPTION OF THE DRAWINGS

Hereinafter, specific embodiments will be described in detail with reference to the accompanying drawings. The inventive concept may, however, be embodied in different forms and should not be construed as limited to the embodiments set forth herein. Rather, these embodiments are provided so that this disclosure will be thorough and complete, and will fully convey the inventive concept to those skilled in the art. As used herein, the term “and/or” includes any one of relevant listed items, or all mixtures of thereof. Like reference numerals refer to like elements throughout. Further, various elements and regions in drawings are roughly drawn. Accordingly, the inventive concept is not limited by relative sizes or distances drawn in the accompanying drawings. In the embodiments, at % (atomic percent) indicates a percentage of the number of atoms in which relevant constituents are occupied in the total number of atoms of the entire alloy.

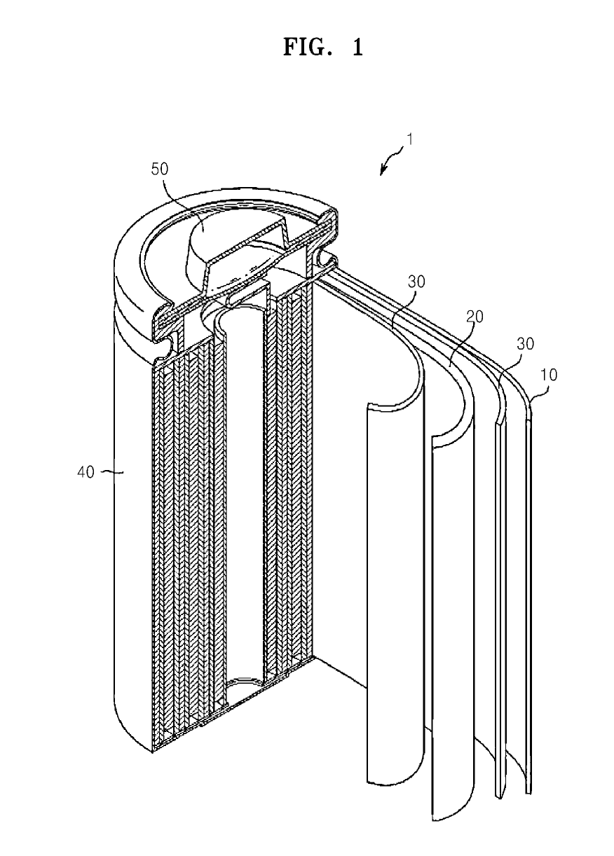

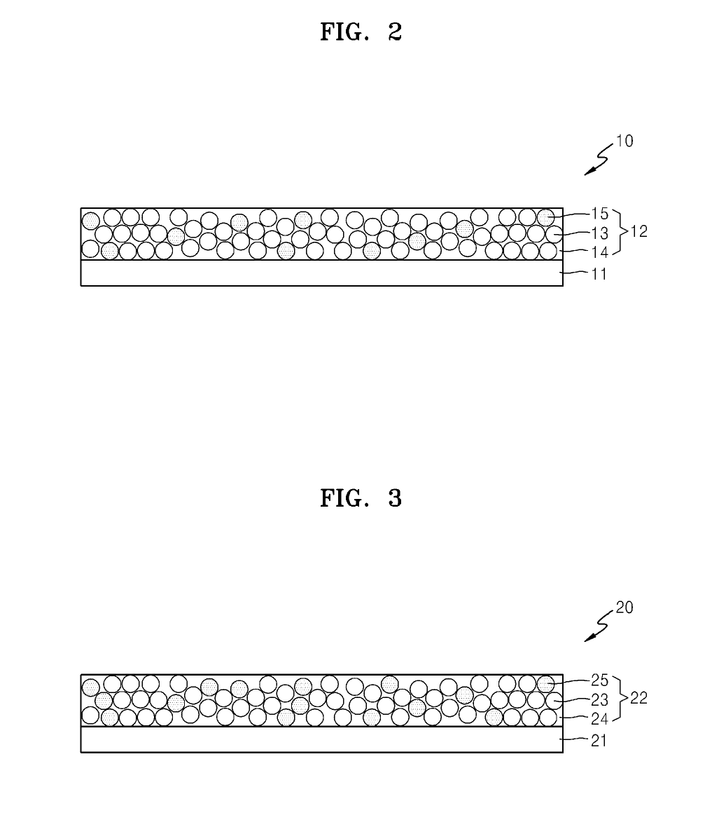

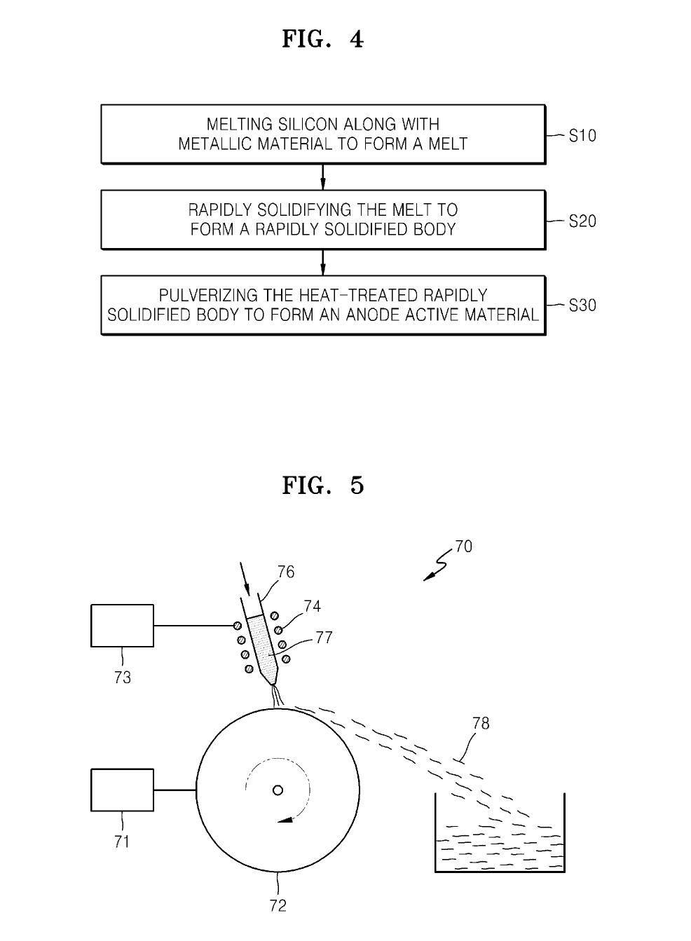

FIG. 1 is a schematic diagram illustrating a secondary battery 1 according to one embodiment. FIG. 2 is a schematic diagram illustrating an anode 10 in the secondary battery 1 of FIG. 1. FIG. 3 is a schematic diagram illustrating a cathode 20 in the secondary battery of FIG. 1.

Referring to FIG. 1, the secondary battery 1 may include an anode 10, a cathode 20, a separator 30 interposed between the anode 10 and the cathode 20, a battery case 40, and a sealing member 50. Further, the secondary battery 1 may additionally include an electrolyte which is not drawn in FIG. 1 and with which the anode 10, cathode 20 and separator 30 are impregnated. Further, the anode 10, cathode 20 and separator 30 may be sequentially laminated and housed in the battery case 40 in a state that the laminated anode, cathode and separator are spirally wound. The battery case 40 may be sealed by the sealing member 50.

The secondary battery 1 may be a lithium secondary battery in which lithium is used as a medium, and the secondary battery 1 may be a lithium ion battery, a lithium ion polymer battery, and a lithium polymer battery according to types of the separator 30 and electrolyte. Further, the secondary battery 1 may be classified into a coin type secondary battery, a button type secondary battery, a sheet type secondary battery, a cylinder type secondary battery, a flat secondary battery, a rectangular secondary battery, and other shaped secondary batteries according to shapes of the secondary battery. The secondary battery 1 may be divided into a bulk type secondary battery and a thin film type secondary battery according to sizes of the secondary battery. The secondary battery 1 illustrated in FIG. 1 is a cylinder type secondary battery illustrated as an example, and the inventive concept is not limited to the cylinder type secondary battery.

Referring to FIG. 2, the anode 10 includes an anode current collector 11 and an anode active material layer 12 placed on the anode current collector 11. The anode active material layer 12 includes an anode active material 13 and an anode binder 14 adhering the anode active material 13. Further, the anode active material layer 12 may selectively include an anode conductive material 15. Further, although it is not drawn in FIG. 2, the anode active material layer 12 may additionally include additives such as a filling agent or a dispersing agent. The anode active material 13, the anode binder 14, and/or the anode conductive material 15 are mixed in a solvent to prepare an anode active material composition, and the anode active material composition is coated on the anode current collector 11 to form the anode 10.

The anode current collector 11 may include conductive materials or may be a thin conducting foil. For example, the anode current collector 11 may include copper, gold, nickel, stainless steel, titanium, or alloys thereof. Further, the anode current collector 11 may be formed as a polymer including conductive metals. Further, the anode current collector 11 may be formed by pressing an anode active material.

For instance, the anode active material 13 may include materials in which anode active materials for lithium secondary batteries can be used, and which are capable of reversible intercalation/deintercalation of lithium ions. For instance, the anode active material 13 may include silicon and metals and may be formed as silicon particles dispersed in a silicon-metal matrix. The metals may be transition metals and may be at least one selected from Al, Cu, Zr, Ni, Ti, Co, Cr, V, Mn, and Fe. The silicon particles may be nano-sized silicon particles. Further, tin, aluminum, antimony, etc. may be used instead of silicon.

The anode active material 13 may include a first element group, a second element group, and a balance of silicon and unavoidable impurities. The anode active material 13 may include an amount of at least one element selected from the first element group in a range of about 0 at % to about 30 at %. The first element group may include copper (Cu), iron (Fe), or a mixture thereof. The second element group may include titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), or mixtures thereof. Further, the anode active material 13 may include an amount of at least one selected from the second element group in a range of about 0 at % to about 20 at %. Further, the anode active material 13 may include silicon and other unavoidable impurities as the balance. The amount of silicon and other unavoidable impurities may be included in a range of about 70 at % to about 85 at %, or in a range of about 75 at % to about 85 at %.

For instance, the anode active material 13 may include an amount of a first element group in a range of about 0 at % to about 30 at %, an amount of a second element group in a range of about 0 at % to about 20 at %, and an amount of silicon and other unavoidable impurities in a range of about 70 at % to about 85 at %. The first element group may include equal amounts of copper and iron. For instance, the first element group may include about 9.5 at % of copper and about 9.5 at % of iron. The second element group may include equal or different amounts of nickel and titanium. The total content of the first element group may be higher than that of the second element group.

The anode binder 14 plays a role of adhering particles of the anode active material 13 to each other, and adhering the anode active material 13 to the anode current collector 11. For instance, the anode binder 14 may include polymers including polyimide, polyamideimide, polybenzimidazole, polyvinyl alcohol, carboxymethyl cellulose, hydroxypropyl cellulose, polyvinyl chloride, poly(vinyl chloride) carboxylated, polyvinyl fluoride, ethylene oxide, polyvinylpyrrolidone, polyurethane, polytetrafluoroethylene, polyvinylidene fluoride, polyethylene, polypropylene, styrene-butadiene, acrylated styrene-butadiene, epoxy resins, etc., or mixtures thereof.

The anode conductive material 15 may further provide conductivity to the anode 10 and may be conductive materials that do not cause chemical changes in the secondary battery 1. For instance, the conductive materials may include carbonaceous materials such as graphite, carbon black, acetylene black, carbon fibers, etc.; metal based materials such as copper, nickel, aluminum, silver, etc.; conductive polymer materials such as polyphenylene derivatives, etc.; or mixtures thereof.

Referring to FIG. 3, the cathode 20 includes a cathode current collector 21 and a cathode active material layer 22 placed on the cathode current collector 21. The cathode active material layer 22 includes a cathode active material 23 and a cathode binder 24 that adheres the cathode active material 23. Further, the cathode active material layer 22 selectively includes a cathode conductive material 25. Further, although not illustrated in FIG. 3, the cathode active material layer 22 may additionally include additives such as a filling agent or a dispersing agent. The cathode active material 23, the cathode binder 24 and/or the cathode conductive material 25 are mixed in a solvent to prepare a cathode active material composition, and the cathode active material composition is coated on the cathode current collector 21 to form the cathode 20.

The cathode current collector 21 may be a thin conductive foil or may include conductive materials. For instance, the cathode current collector 21 may include aluminum, nickel or an alloy thereof, may be formed in a polymer including conductive metals, or may be formed by pressing the anode active material.

For instance, the cathode active material 23 may include materials in which cathode active materials for lithium secondary batteries can be used, and which are capable of reversible intercalation/deintercalation of lithium ions. The cathode active material 23 may include lithium-containing transition metal oxides; lithium-containing transition metal sulfides, etc.; or mixtures thereof. Examples of the cathode active material 23 may include at least one selected from LiCoO₂, LiNiO₂, LiMnO₂, LiMn₂O₄, Li(NiₐCo_{b}Mn_{c})O₂ (0<a<1, 0<b<1, 0<c<1, a+b+c=1), LiNi_{1-y}Co_{y}O₂, LiCo_{1-y}Mn_{y}O₂, LiNi_{1-y}Mn_{y}O₂ (0=Y<1), Li(NiₐCo_{b}Mn_{c})O4 (0<a<2, 0<b<2, 0<c<2, a+b+c=2), LiMn_{2-z}Ni_{z}O₄, LiMn_{2-z}Co_{z}O₄ (0<z<2), LiCoPO₄, and LiFePO₄.

The cathode binder 24 plays a role of adhering particles of the cathode active material 23 to each other, and adhering the cathode active material 23 to the cathode current collector 21. For instance, the cathode binder 24 may be polymers including polyimide, polyamideimide, polybenzimidazole, polyvinyl alcohol, carboxymethyl cellulose, hydroxypropyl cellulose, polyvinyl chloride, poly(vinyl chloride) carboxylated, polyvinyl fluoride, ethylene oxide, polyvinylpyrrolidone, polyurethane, polytetrafluoroethylene, polyvinylidene fluoride, polyethylene, polypropylene, styrene-butadiene, acrylated styrene-butadiene, epoxy resins, etc., or mixtures thereof.

The cathode conductive material 25 may further provide conductivity to the cathode 20 and may include conductive materials that do not cause chemical changes in the secondary battery 1. For instance, the conductive materials may include carbonaceous materials such as graphite, carbon black, acetylene black, carbon fibers, etc.; metal based materials such as copper, nickel, aluminum, silver, etc.; conductive polymer materials such as polyphenylene derivatives, etc.; or mixtures thereof.

Referring to FIG. 1 again, the separator 30 may have porosity, and may be formed in a single film or multiple films consisting of two or more layers. The separator 30 may include polymer materials. For instance, the polymer materials may include at least one selected from polyethylene-based polymers, polypropylene-based polymers, polyvinylidene fluoride-based polymers, polyolefin-based polymers, etc.

An electrolyte which is not drawn in the drawing and with which the anode 10, the cathode 20 and the separator 30 are impregnated may include a non-aqueous solvent and an electrolyte salt. The non-aqueous solvent is not particularly limited if the non-aqueous solvent may be used as an ordinary non-aqueous solvent for a non-aqueous electrolyte. Examples of the non-aqueous solvent may include carbonate-based solvents, ester-based solvents, ether-based solvents, ketone-based solvents, alcohol-based solvents, aprotic solvents, or mixtures thereof. The examples of the non-aqueous solvent may be used separately or in the form of mixtures of thereof. The mixing ratio may be properly adjusted according to a target battery performance when mixing of the examples of the non-aqueous solvent.

The electrolyte salt is not particularly limited if the electrolyte salt may be used as an ordinary electrolyte salt for a non-aqueous electrolyte. Examples of the electrolyte salt may include salts having a structural formula of A⁺B⁻, wherein A⁺ may be ions including alkali metal cations such as Li⁺, Na⁺, K⁺, etc., or mixtures thereof, and B⁻ may be ions including anions such as PF₆⁻, BF₄⁻, Cl⁻, Br⁻, I⁻, ClO₄⁻, ASF₆⁻, CH₃CO₂⁻, CF₃SO₃⁻, N(CF₃SO₂)₂⁻, C(CF₂SO₂)₃⁻, etc., or mixtures thereof. The examples of the electrolyte salt may include LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (x and y are natural numbers), LiCl, LiI, LiB(C₂O₄)₂, or mixtures thereof. The examples of the electrolyte salt may be used separately or in the form of mixtures of two or more thereof.

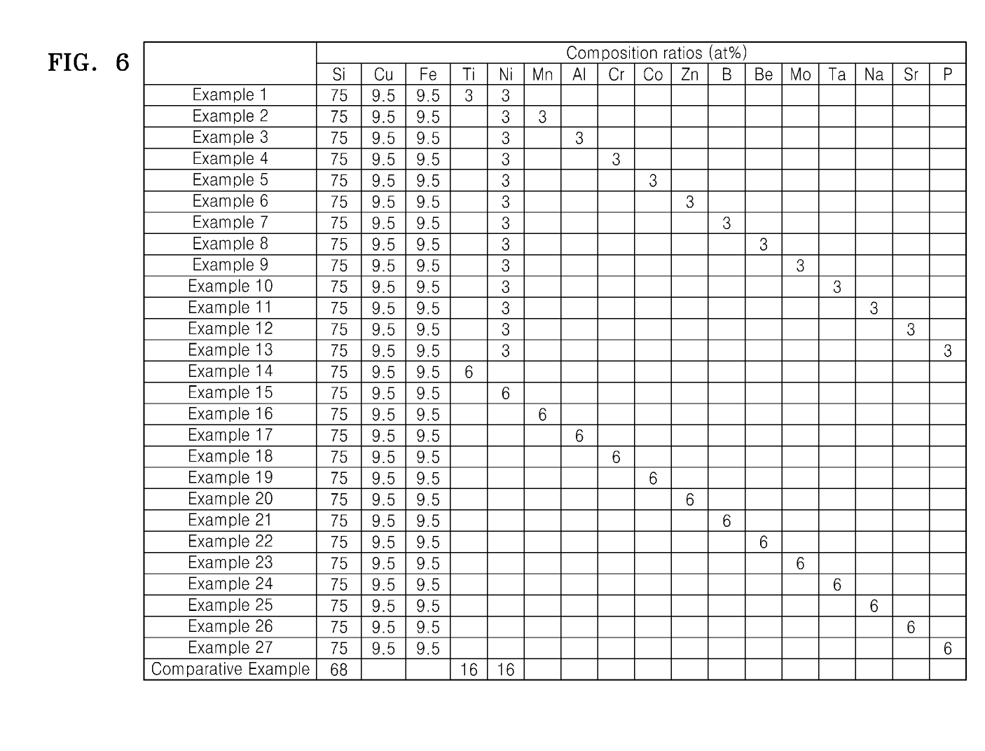

FIG. 4 is a flow chart illustrating a method of preparing an anode active material 13 included in an anode 10 of a secondary battery 1 according to one embodiment.

Referring to FIG. 4, the method includes the step of melting a first element group, a second element group and silicon all together to form a melt (S10). For instance, the step of melting may be embodied through the generation of induced heat of silicon, a first element group or a second element group according to high frequency induction using a high frequency induction furnace. Additionally, the melt may be formed by using an arc melting process, etc. The melt may include an amount of the first element group in a range of about 0 at % to about 30 at % . The first element group may include copper, iron, or a mixture thereof. The melt may include an amount of the second element group in a range of about 0 at % to about 20 at %. The second element group may include titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), or mixtures thereof. The melt may include a balance of silicon and other unavoidable impurities. The amount of silicon and other unavoidable impurities may be in a range of about 70 at % to about 85 at % or in a range of about 75 at % to about 80 at %.

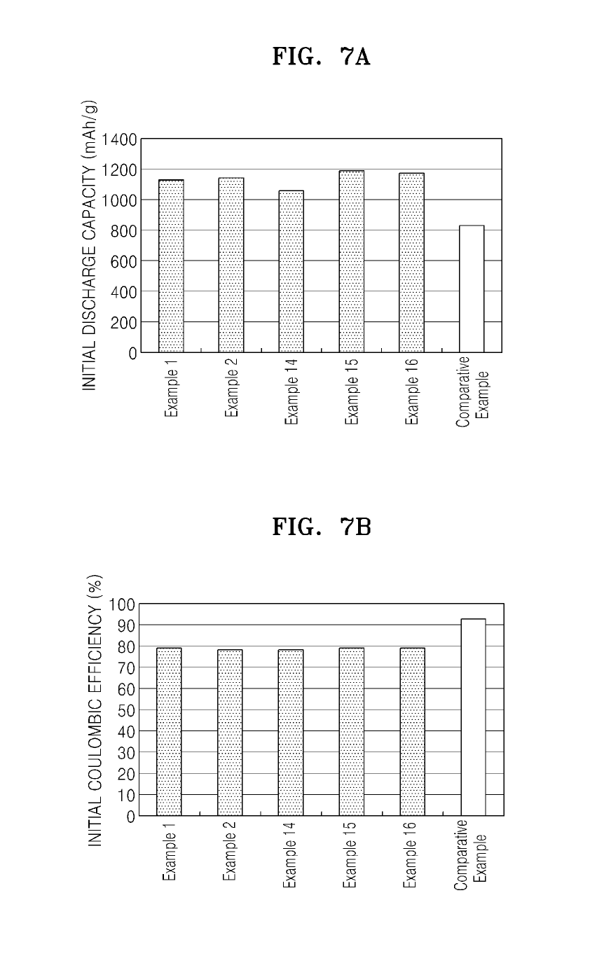

Subsequently, the method includes the step of rapidly solidifying the melt to form a rapidly solidified body (S20). The rapidly solidified body may be formed using a melt spinner of FIG. 5, and the rapidly solidified body is described below in detail in referring to FIG. 5. However, those skilled in the art may understand that the rapidly solidified body may be formed by other methods of using an atomizer, etc. besides the melt spinner. The rapidly solidified body may include a silicon single phase and a silicon-metal alloy phase.

Subsequently, the method optionally includes the step of performing heat treatment of the rapidly solidified body. A crystal or a phase included in the rapidly solidified body may be subjected to recrystallization and/or grain growth by the heat treatment. The heat treatment may be performed in a vacuum atmosphere, an inert atmosphere including nitrogen, argon, helium or mixtures thereof, or a reducing atmosphere including hydrogen, etc. Further, the heat treatment may be embodied in a vacuum atmosphere or by circulating such inert gases as nitrogen, argon, helium, etc. The heat treatment may be performed in a temperature range from about 400° C. to about 800° C. for a period of time from about 1 minute to about 60 minutes. Further, after performing the heat treatment step, the heat-treated crystal or phase may be cooled in a cooling rate range from about 4° C./min to about 2° C./min. Further, the heat treatment may be performed at a temperature that is about 200° C. lower than a melting temperature of the rapidly solidified body. Characteristics of a microstructure of the rapidly solidified body may be changed by the heat treatment.

Subsequently, the method includes the step of pulverizing the rapidly solidified body to form an anode active material (S30). The pulverized anode active material may be a powder having a particle diameter from several micrometers to hundreds of micrometers. The powder may have a particle diameter ranged from about 1 μm to about 10 μm. For instance, the powder may have a particle diameter ranged from about 2 μm to about 4 μm. The pulverizing process may be performed using publicly known processes such as a milling process a ball milling process, etc. for pulverizing alloys into alloy powders. For instance, the time of the ball milling process may be controlled to control the particle sizes of the pulverized powders. According to one embodiment, the rapidly solidified body is ball milled from about 20 hours to about 50 hours such that the anode active material may be formed as a powder having a particle diameter of several micrometers.

Such an anode active material may correspond to the above-described anode active material 13 by referring to FIG. 1. Further, after the anode active material is mixed with the anode binder 14, etc. to form a slurry as described above referring to FIG. 1, the slurry is coated on the anode current collector 11 to embody an anode 10 of the secondary battery 1.

FIG. 5 is a schematic diagram illustrating a method of forming an anode active material according to an embodiment.

Referring to FIG. 5, an anode active material according to an embodiment may be formed using a melt spinner 70. The melt spinner 70 includes a cooling roll 72, a high frequency induction coil 74, and a tube 76. The cooling roll 72 may be formed of metal having high thermal conductivity and thermal shock properties. For instance, the cooling roll 72 may be formed of copper or copper alloys. The cooling roll 72 may be rotated to a high speed by a rotation means 71 such as a motor. For instance, the cooling roll 72 may be rotated to a speed range from about 1000 to about 5000 revolutions per minute. The high frequency induction coil 74 enables a high frequency power to be flown by a high frequency induction means which is not illustrated in FIG. 5 such that a high frequency is induced to material charged into the tube 76 accordingly. A cooling medium for cooling the high frequency induction coil 74 flows in the high frequency induction coil 74. The tube 76 may be formed using materials such as quartz, fire resistant glass, etc., which have low reactivity with charged material and have high heat resistance. A high frequency is induced to the tube 76 by the high frequency induction coil 74, and materials to be melted such as silicon and metallic materials are charged into the tube 76. The high frequency induction coil 74 is wound around the tube 76 and melts the materials charged into the tune 76 by high frequency induction such that a liquid-phase melt 77 or a melt 77 having fluidity may be formed. The tube 76 may prevent undesirable oxidation of the melt 77 in a vacuum or inert atmosphere. When the melt 77 is formed, a compressed gas, e.g., an inert gas such as argon or nitrogen is injected into the tube 76 from one side of the tube 76 as represented by an arrow, and the melt 77 is discharged by the compressed gas through a nozzle formed at the other side of the tube 76. The melt 77 discharged from the tube 76 is brought into contact with a cooling roll 72 and rapidly cooled by the cooling roll to form a rapidly solidified body 78. The rapidly solidified body 78 may have a ribbon shape, a flake shape, or a powder shape. The melt 77 may be cooled at a high rate by rapid solidification using such a cooling roll. For instance, the melt 77 may be cooled at a cooling rate from about 10³° C./sec to about 10⁷° C./sec. The cooling rate may vary depending on a rotary speed, material, temperature, etc. of the cooling roll 72.

Therefore, since rapid precipitation of a silicon single phase within the melt is possible if a rapidly solidified body is formed using a melt spinner, the silicon single phase may form an interface with a silicon-metal alloy phase within the rapidly solidified body, and the silicon single phase may be uniformly distributed into the silicon-metal alloy phase.

When a melt including a first element group, a second element group and a balance of silicon is rapidly solidified according to certain embodiments, refinement of the silicon single phase precipitated within the rapidly solidified body may be promoted.

For instance, copper or iron included in the first element group may function as a matrix such that the silicon single phase may be minutely precipitated within the silicon-metal alloy phase. In general, the higher a silicon content of an anode active material using a silicon-metal alloy is, the more severe a volume change which is generated as lithium is intercalated or deintercalated into a silicon grain is. Accordingly, the anode active material using a silicon-metal alloy does not have excellent suitability as an anode active material for a secondary battery since cracking or fine particles are generated in the anode active material layer. Therefore, the silicon single phase is dispersed into the silicon-metal alloy phase to buffer the volume change by controlling a content of silicon such that the content of silicon does not exceed about 50 at %. In this case, since the content of silicon used as an active region in which intercalation/deintercalation of lithium may occur is decreased, a discharge capacity is decreased. However, when the first element group includes copper and iron, the silicon single phase may be uniformly distributed in a silicon-copper-iron alloy matrix. Accordingly, the anode active material may exhibit excellent cycle characteristics even if the silicon content is high such that the silicon content exceeds about 70 at %.

Further, titanium, nickel, manganese, aluminum, chromium, cobalt, zinc, boron, beryllium, molybdenum, tantalum, sodium, strontium or phosphorous included in the second element group may promote refinement of the silicon-metal alloy phase. For instance, elements such as boron, beryllium, etc. are elements that promote amorphization of the silicon single phase. Therefore, a uniform silicon single phase having a small particle size may be precipitated when the melt is rapidly solidified in an amorphous supercooled state. Further, elements with a high melting point such as tantalum and molybdenum may function to provide a nucleation site of the silicon single phase. Accordingly, the silicon single phase having fine particle sizes may be uniformly precipitated in a melt including a large amount of the nucleation site. For instance, a silicon single phase having a fine particle size may be obtained as elements such as sodium, strontium, phosphorous, etc. inhibit grain growth of the silicon single phase from the melt.

In one embodiment, a melt comprising a first element group, a second element group and silicon is rapidly solidified to form an anode active material in which a micro-sized silicon single phase is uniformly distributed in a silicon-metal alloy phase. The first element group includes copper, iron or a mixture thereof, and the second element group includes elements that promote refinement of the silicon single phase. Therefore, an anode active material having excellent cycle characteristics and discharge capacity may be provided in spite of a high content of silicon.

The anode active materials are excellent in initial discharge capacities and cycle characteristics although silicon has a high content, and nickel and titanium have low contents. Accordingly, anode active materials for secondary batteries having excellent electrochemical performances and economic efficiencies may be provided since contents of expensive nickel and titanium can be reduced.

### EXAMPLES

Hereinafter, excellent electrochemical performances of the Examples are described in detail through the Examples.

### 1. Preparation of Anode Active Materials in the Examples

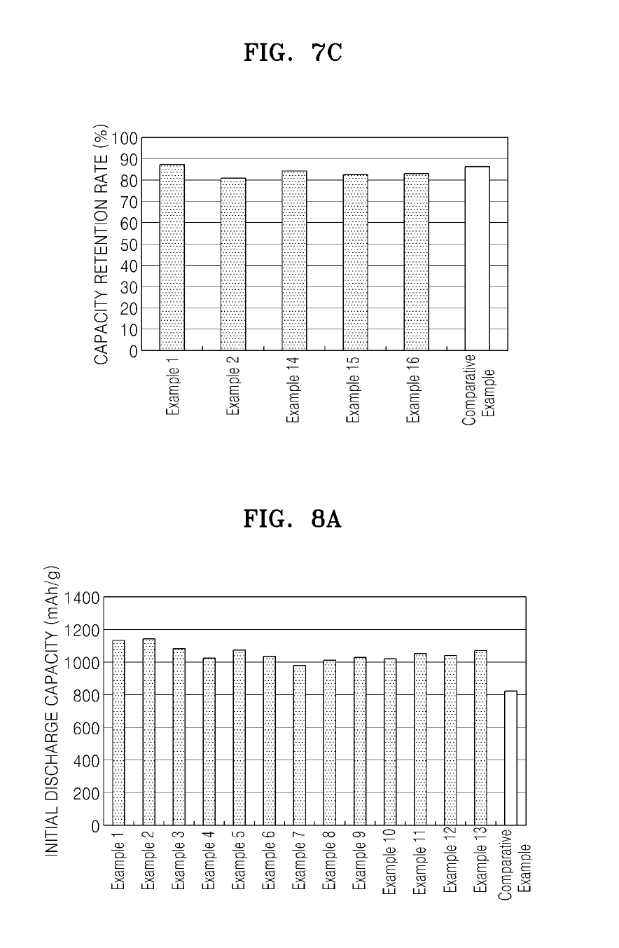

FIG. 6 shows composition ratios of substances composing anode active materials in the Examples.

In Examples 1 to 26, a melt including a first element group, a second element group and silicon having an atomic percent (at %) was formed as illustrated in FIG. 6. For instance, the first element group including about 9.5 at % of copper and about 9.5 at % of iron, the second element group including about 3 at % of titanium and about 3 at % of nickel, and a balance of about 75 at % of silicon were mixed to form a melt in the Example 1. That is, copper and iron were selected as elements for the first element group, and equal amounts of copper and iron were included in the second element group. Further, titanium and nickel were selected as elements for the second element group. Contents of copper and iron were fixed equally, and types of the elements for the second element group were varied to form the melt in all the Examples.

Further, about 16 at % of titanium, about 16 at % of nickel and about 68 at % of silicon were mixed to form a melt in the Comparative Example. It should be noted that copper and iron are not mixed in the Comparative Example.

After the melt including elements having the above-described atomic percentages was rapidly solidified to form a rapidly solidified body, ball milling of the rapidly solidified body was performed for about 48 hours to form an anode active material in a powder state. Therefore, such formed anode active material includes a silicon single phase uniformly distributed in a silicon-metal alloy phase.

### 2. Preparation of Half-Cells

Half-cells were manufactured to evaluate electrochemical characteristics of the anode active materials prepared as described above. Coin cells were manufactured by using metal lithium as reference electrodes and using anodes formed by adding a binder and a conducting material in the anode active materials formed in the Examples 1 to 26 as measuring electrodes.

### 3. Evaluation of Charging and Discharging Characteristics

Initial discharge capacity, initial coulombic efficiency, discharge capacity after the 40th cycle, and capacity retention rate after the 40th cycle were measured on the half-cells prepared as described above. First cycle and second cycles of charge/discharge were performed on the prepared half-cells respectively at current densities of about 0.1 C and about 0.2 C, and third or more cycles of charge/discharge were performed on the prepared half-cells at a current density of about 1.0 C.

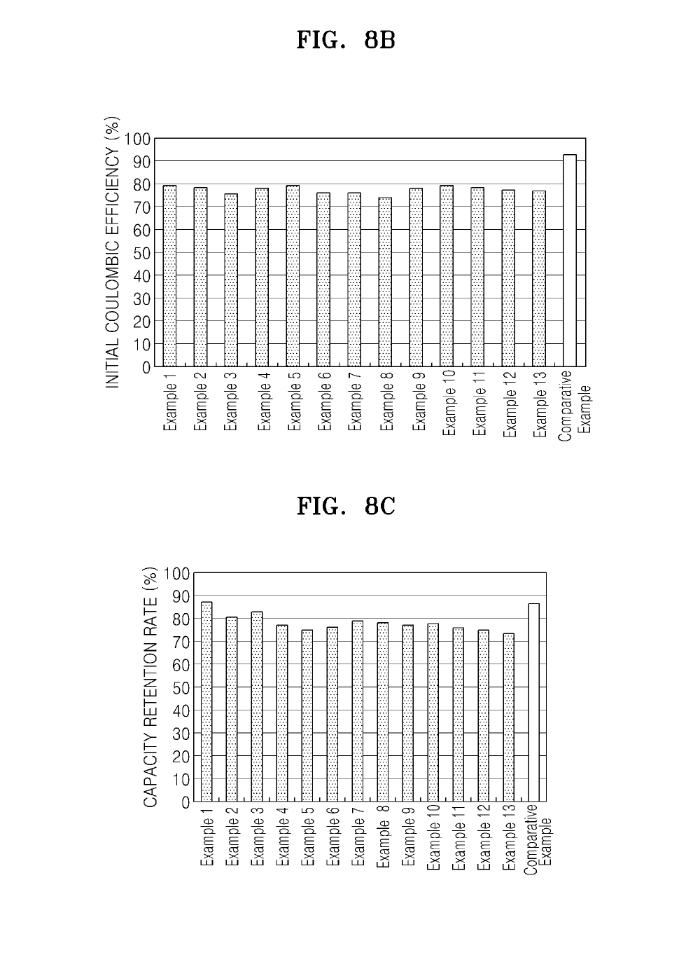

FIGS. 7A to 10B are graphs showing electrochemical performances of anode active materials according to certain embodiments.

In FIGS. 7A to FIG. 7C, electrochemical performances of the Examples including reduced amounts of nickel and titanium were compared with one another. Specifically, initial discharge capacity (FIG. 7A), initial coulombic efficiency (FIG. 7B), and capacity retention rate (FIG. 7C) of Example 1, Example 2 and Examples 14 to 16 including various amounts of copper and iron as elements for a first element group and nickel, titanium or a mixture thereof as elements for a second element group were compared to one another, and the comparison results are illustrated in the drawings. Further, electrochemical performance of an anode active material including about 16 at % of nickel, about 16 at % of titanium, and about 68 at % of silicon as the Comparative Example was compared with those of Example 1, Example 2 and Examples 14 to 16.

Numbers for elements denoted in compositions of Tables 1 to 3 mean atomic percentages. For instance, Si₇₅Cu_{9.5}Fe_{9.5}Ni₃Ti₃ denotes about 75 at % of Si, about 9.5 at % of Cu, about 9.5 at % of Fe, about 3 at % of Ni, and about 3 at % of Ti.

TABLE 1

| | | | Ratio of | | Discharge | |
|---|---|---|---|---|---|---|
| | | | initial | | capacity | |
| | | Initial | capacity to | Initial | after the | |
| | | discharge | Comparative | coulombic | 40th | Capacity |
| | | capacity | Example | efficiency | cycle | retention |
| Examples | Compositions | (mAh/g) | (%) | (%) | (mAh/g) | rate (%) |
| Example 1 | Si₇₅Cu_{9.5}Fe_{9.5}Ni₃Ti₃ | 1131 | 137 | 79.1 | 948 | 87.2 |
| Example 2 | Si₇₅Cu_{9.5}Fe_{9.5}Ni₃Mn₃ | 1142 | 138 | 78.2 | 870 | 80.6 |
| Example 14 | Si₇₅Cu_{9.5}Fe_{9.5}Ti₆ | 1057 | 128 | 78.3 | 838 | 84.6 |
| Example 15 | Si₇₅Cu_{9.5}Fe_{9.5}Ni₆ | 1189 | 144 | 79.5 | 925 | 82.6 |
| Example 16 | Si₇₅Cu_{9.5}Fe_{9.5}Mn₆ | 1172 | 142 | 79.3 | 921 | 83 |
| Comparative | Si₆₈Ti₁₆Ni₁₆ | 827 | 100 | 92.6 | 601 | 86.3 |
| Example | | | | | | |

Referring to FIG. 7A, the Examples show excellent discharge capacity characteristics as initial discharge capacities of the Examples are maximally about 144% higher than an initial discharge capacity of the Comparative Example.

The Examples respectively include about 9.5 at % of copper, about 9.5 at % of iron, about 3 at % to about 6 at % of nickel, and/or about 3 at % to about 6 at % of titanium. The Examples show excellent discharge capacities, e.g., a discharge capacity of about 1131 mAh/g when Example 1 includes about 3 at % of nickel and about 3 at % of titanium, a discharge capacity of about 1057 mAh/g when Example 14 includes about 6 at % of titanium, and a discharge capacity of about 1189 mAh/g when Example 15 includes about 6 at % of nickel. An anode active material including about 16 at % of titanium, about 16 at % of nickel, and about 68 at % of silicon was used as the Comparative Example showing an initial discharge capacity of about 827 mAh/g. Therefore, the Examples show discharge capacities which are improved as much as about 128% to about 144% compared to that of the Comparative Example.

One reason that the Examples show improved initial discharge capacities is an increase in the content of silicon. However, the silicon content was increased as much as about 10% in the Examples (about 75 at % of Si) compared to that of the Comparative Example (about 68 at % of Si), and initial discharge capacities were increased as much as about 127% to about 144%. Therefore, it can be supposed that the content of silicon functioning as an active region was increased according as not only the content of silicon was increased, but also a silicon single phase was finely dispersed.

Referring to FIG. 7B, the Examples exhibit initial coulombic efficiencies from about 78.3% to about 79.5% which are somewhat lower than an initial coulombic efficiency of about 92.6% of the Comparative Example. Here, the initial coulombic efficiency means a ratio of the initial discharge capacity to the initial charge capacity. Therefore, it can be seen that the Examples have greater initial charge capacities.

Referring to FIG. 7C, the Examples exhibit excellent cycle characteristics. The cycle characteristics were compared as discharge capacities after about 40 cycles of charge/discharge, and the capacity retention rates were defined as percentage of about 40 cycles of discharge capacities to the initial discharge capacity. The Comparative Examples exhibits about 86.3% of capacity retention rate, and Example 1 exhibits about 87.2% of capacity retention rate that is a little more excellent than that of the Comparative Example. The other Examples except Example 1 exhibit about 80.6% to about 84.6% of capacity retention rates. Therefore, it can be seen that the other Examples except Example 1 exhibit good cycle characteristics that are about 80% or higher, although capacity retention rates of the other Examples except Example 1 are a little lower than that of the Comparative Example.

Anode active materials including silicon had a conventional problem that volume changes of the anode active materials were severe during charge/discharge, and cracking, etc. were occurred when performing the charge/discharge processes so that it was difficult to use the anode active materials including silicon as an anode. Therefore, studies have been conducted to relieve volume expansion of the anode active materials by using silicon-metal alloy anode materials having metallic materials added in silicon as the anode active materials. Examples of the metal mainly included expensive metals such as nickel, titanium, etc. There were such problems that volumes of the anode active materials were increased during charge/discharge since intermetallic compounds were formed, or abnormally coalesced silicon crystals were formed without a silicon single phase being uniformly distributed in the silicon-metal alloy in case of a high content of silicon. Therefore, discharge capacities of the anode active materials could not be increased since silicon was conventionally contained in the amount of about 50 at % or less. Further, there were problems that costs of the anode active materials were increased since expensive nickel and titanium metals were used in the anode active materials as in the case of the Comparative Example including about 16 at % of nickel and about 16 at % of titanium.

The Examples exhibit excellent capacity retention rates although silicon is contained in the anode active materials in an amount of up to about 75 at % since nickel and titanium are added in anode active materials according to the Examples in a small amount from about 3 at % to about 6 at %, and copper and iron are included in the anode active materials. Initial discharge capacities of the Examples may also be substantially increased compared to that of the Comparative Example. Accordingly, anode active materials having excellent electrochemical performances may be provided at relatively low costs.

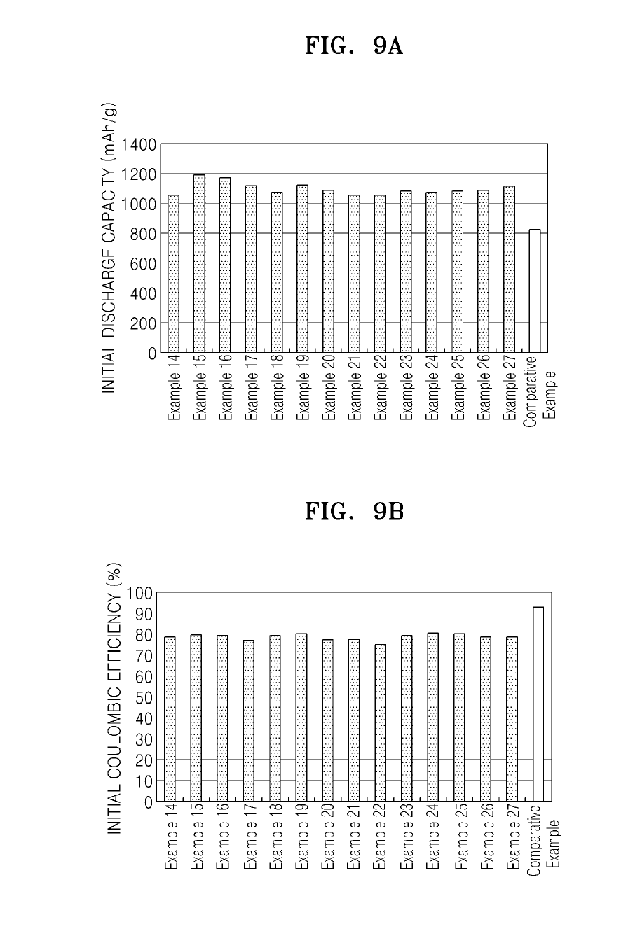

Initial discharge capacities (FIG. 8A), initial coulombic efficiencies (FIG. 8B) and capacity retention rates (FIG. 8C) of Examples 1 to 13 were compared, and the comparison results were illustrated in FIGS. 8A to 8C. Examples 1 to 13 commonly include about 9.5 at % of copper, about 9.5 at % of iron, about 3 at % of nickel and about 75 at % of silicon, and include titanium, manganese, aluminum, chromium, cobalt, zinc, boron, beryllium, molybdenum, tantalum, sodium, strontium, and phosphorous in amounts of about 3 at % respectively. An anode active material including about 16 at % of nickel, about 16 at % of titanium and about 64 at % of silicon was illustrated as the Comparative Example.

TABLE 2

| | | | Ratio of | | Discharge | |
|---|---|---|---|---|---|---|
| | | | initial | | capacity | |
| | | Initial | capacity to | Initial | after the | |
| | | discharge | Comparative | coulombic | 40th | Capacity |
| | | capacity | Example | efficiency | cycle | retention |
| Examples | Compositions | (mAh/g) | (%) | (%) | (mAh/g) | rate (%) |
| Example 1 | Si₇₅Cu_{9.5}Fe_{9.5}Ni₃Ti₃ | 1131 | 137 | 79.1 | 948 | 87 |
| Example 2 | Si₇₅Cu_{9.5}Fe_{9.5}Ni₃Mn₃ | 1142 | 138 | 78.2 | 870 | 80.6 |
| Example 3 | Si₇₅Cu_{9.5}Fe_{9.5}Ni₃Al₃ | 1086 | 131 | 75.8 | 846 | 82.9 |
| Example 4 | Si₇₅Cu_{9.5}Fe_{9.5}Ni₃Cr₃ | 1027 | 124 | 78.1 | 741 | 77.2 |
| Example 5 | Si₇₅Cu_{9.5}Fe_{9.5}Ni₃Co₃ | 1075 | 130 | 79.3 | 756 | 74.9 |
| Example 6 | Si₇₅Cu_{9.5}Fe_{9.5}Ni₃Zn₃ | 1035 | 125 | 75.9 | 742 | 76.1 |
| Example 7 | Si₇₅Cu_{9.5}Fe_{9.5}Ni₃B₃ | 982 | 119 | 76.1 | 729 | 79.2 |
| Example 8 | Si₇₅Cu_{9.5}Fe_{9.5}Ni₃Be₃ | 1013 | 123 | 74 | 742 | 78.1 |
| Example 9 | Si₇₅Cu_{9.5}Fe_{9.5}Ni₃Mo₃ | 1031 | 125 | 77.9 | 747 | 77 |
| Example 10 | Si₇₅Cu_{9.5}Fe_{9.5}Ni₃Ta₃ | 1021 | 124 | 79.1 | 748 | 77.9 |
| Example 11 | Si₇₅Cu_{9.5}Fe_{9.5}Ni₃Na₃ | 1054 | 128 | 78.1 | 751 | 75.9 |
| Example 12 | Si₇₅Cu_{9.5}Fe_{9.5}Ni₃Sr₃ | 1041 | 126 | 77.2 | 736 | 75.1 |
| Example 13 | Si₇₅Cu_{9.5}Fe_{9.5}Ni₃P₃ | 1072 | 130 | 76.8 | 738 | 73 |
| Comparative | Si₆₈Ti₁₆Ni₁₆ | 826.5 | 100 | 92.6 | 601 | 86.3 |
| Example | | | | | | |

Referring to FIG. 8A, the Examples exhibit initial discharge capacities from about 982 mAh/g to about 1142 mAh/g that correspond to about 119% to about 138% of the initial discharge capacity of the Comparative Example. Namely, the Examples exhibit excellent initial discharge capacities.

Referring to FIG. 8B and 8C, the Examples show about 74.0% to about 79.3% of initial coulombic efficiencies and exhibit about 73.1% to about 87.2% of capacity retention rates after the 40th cycle of charge/discharge. The Examples are excellent in initial discharge capacity and cycle characteristics although the Examples include a high amount of silicon and low amounts of nickel and titanium. Therefore, the Examples can provide anode active materials for secondary batteries having economic efficiency and excellent electrochemical performance since the amounts of expensive nickel and titanium can be reduced.

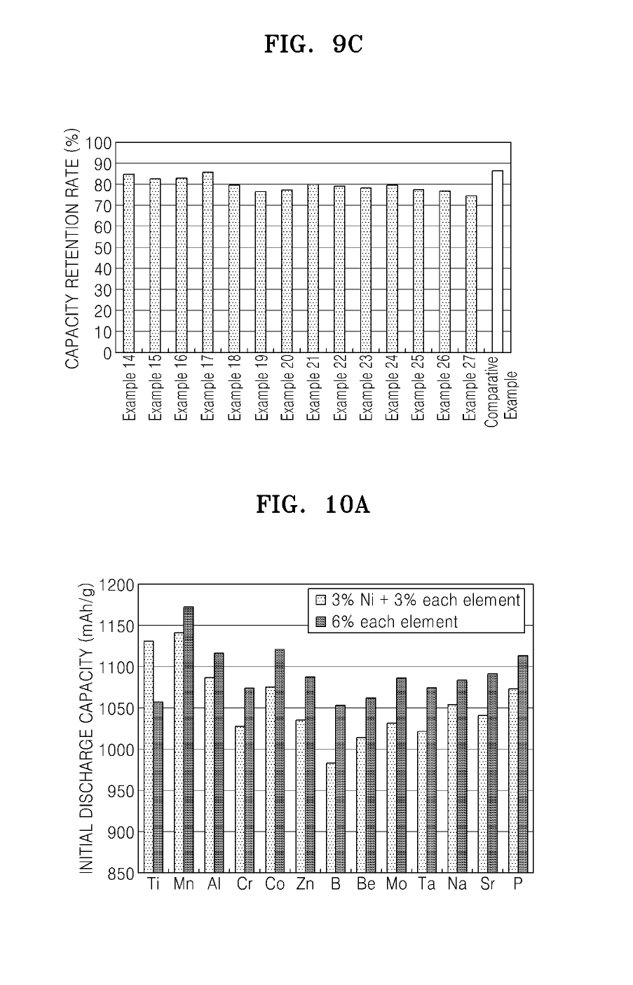

Initial discharge capacities (FIG. 9A), initial coulombic efficiencies (FIG. 9B) and capacity retention rates (FIG. 9C) of Examples 14 to 27 were compared, and the comparison results were illustrated in FIGS. 9A to 9C. Examples 14 to 27 commonly include about 9.5 at % of copper, about 9.5 at % of iron and about 75 at % of silicon, and include titanium, nickel, manganese, aluminum, chromium, cobalt, zinc, boron, beryllium, molybdenum, tantalum, sodium, strontium, and phosphorous in amounts of about 6 at % respectively. An anode active material including about 16 at % of nickel, about 16 at % of titanium and about 64 at % of silicon was illustrated as Comparative Example.

TABLE 3

| | | | Ratio of | | Discharge | |
|---|---|---|---|---|---|---|
| | | | initial | | capacity | |
| | | Initial | capacity to | Initial | after the | |
| | | discharge | Comparative | coulombic | 40th | Capacity |
| | | capacity | Example | efficiency | cycle | retention |
| Examples | Compositions | (mAh/g) | (%) | (%) | (mAh/g) | rate (%) |
| Example 14 | Si₇₅Cu_{9.5}Fe_{9.5}Ti₆ | 1057 | 128 | 78.3 | 838 | 84.6 |
| Example 15 | Si₇₅Cu_{9.5}Fe_{9.5}Ni₆ | 1189 | 144 | 79.5 | 925 | 82.6 |
| Example 16 | Si₇₅Cu_{9.5}Fe_{9.5}Mn₆ | 1172 | 142 | 79.3 | 921 | 83 |
| Example 17 | Si₇₅Cu_{9.5}Fe_{9.5}Al₆ | 1116 | 135 | 77.2 | 899 | 86 |
| Example 18 | Si₇₅Cu_{9.5}Fe_{9.5}Cr₆ | 1073 | 130 | 79.1 | 804 | 79.6 |
| Example 19 | Si₇₅Cu_{9.5}Fe_{9.5}Co₆ | 1121 | 136 | 80.2 | 810 | 76.3 |
| Example 20 | Si₇₅Cu_{9.5}Fe_{9.5}Zn₆ | 1087 | 132 | 77.1 | 793 | 77.2 |
| Example 21 | Si₇₅Cu_{9.5}Fe_{9.5}B₆ | 1053 | 127 | 77.3 | 792 | 80 |
| Example 22 | Si₇₅Cu_{9.5}Fe_{9.5}Be₆ | 1062 | 128 | 75 | 795 | 79.3 |
| Example 23 | Si₇₅Cu_{9.5}Fe_{9.5}Mo₆ | 1086 | 131 | 79.2 | 797 | 78.1 |
| Example 24 | Si₇₅Cu_{9.5}Fe_{9.5}Ta₆ | 1074 | 130 | 80 | 804 | 79.6 |
| Example 25 | Si₇₅Cu_{9.5}Fe_{9.5}Na₆ | 1083 | 131 | 79.7 | 793 | 77.5 |
| Example 26 | Si₇₅Cu_{9.5}Fe_{9.5}Sr₆ | 1091 | 132 | 78.7 | 791 | 76.7 |
| Example 27 | Si₇₅Cu_{9.5}Fe_{9.5}P₆ | 1113 | 135 | 78.5 | 783 | 75 |
| Comparative | Si₆₈Ti₁₆Ni₁₆ | 826.5 | 100 | 92.6 | 601 | 86.3 |
| Example | | | | | | |

Referring to FIGS. 9A to 9C, the Examples exhibit excellent initial discharge capacities. Namely, the Examples exhibit initial discharge capacities from about 1053 mAh/g to about 1189 mAh/g that correspond to about 127% to about 144% of the initial discharge capacity of the Comparative Example. Further, the Examples show 75.1% to 80.3% of initial coulombic efficiencies and exhibit about 74.6% to about 85.6% of capacity retention rates after the 40th cycle of charge/discharge. The Examples are excellent in initial discharge capacity and cycle characteristics although the Examples include a high amount of silicon and low amounts of nickel and titanium. Therefore, the Examples can provide anode active materials for secondary batteries having economic efficiency and excellent electrochemical performance since the amounts of expensive nickel and titanium can be reduced.

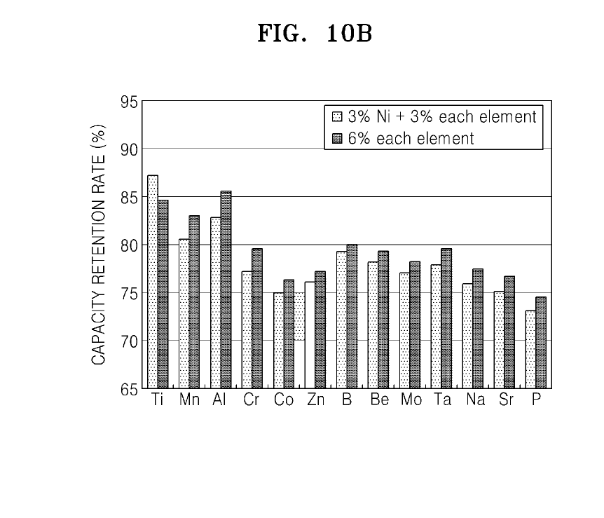

In order to examine electrochemical performance variations according to types of the second element group, electrochemical performances of anode active materials of which addition amounts were varied per elements were illustrated in FIGS. 10A and 10B.

The Examples represented by about 3% in FIGS. 10A and 10B commonly include about 75 at % of silicon, about 9.5 at % of copper, about 9.5 at % of iron and about 3 at % of nickel, and additionally include 3 at % of respective elements represented in FIGS. 10A and 10B. For instance, about 3% of cobalt represents an anode active material including about 75 at % of silicon, about 9.5 at % of copper, about 9.5 at % of iron, about 3 at % of nickel, and about 3 at % of cobalt.

Further, the Examples represented by 6% in FIGS. 10A and 10B commonly include about 75 at % of silicon, about 9.5 at % of copper and about 9.5 at % of iron, and additionally include about 6 at % of respective elements represented in FIGS. 10A and 10B. For instance, about 6% of cobalt represents an anode active material including about 75 at % of silicon, about 9.5 at % of copper, about 9.5 at % of iron, and about 6 at % of cobalt.

Referring to FIGS. 10A and 10B, it can be seen that initial discharge capacities and capacity retention rates of the Examples including about 6% of elements are more excellent than those of the Examples including about 3% of elements. Particularly, respective Examples including manganese, aluminum, cobalt or phosphorous have very excellent initial discharge capacities. Respective Examples including titanium, manganese or aluminum exhibit the most excellent capacity retention rates.

Further, the Examples including about 9 at % to about 10 at % of copper, about 9 at % to about 10 at % of iron and about 5 at % to about 7 at % of cobalt as elements, and a balance of silicon also exhibit similar results. Additionally, the Examples including about 5 at % to about 7 at % of the second element group instead of cobalt also exhibit similar results.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

1. An anode active material for a secondary battery comprising:
an amount of a first element group in a range of about 0 at % to about 30 at %;
an amount of a second element group in a range of about 0 at % to about 20 at %; and
an amount of silicon and other unavoidable impurities,
wherein the first element group comprises copper (Cu), iron (Fe), and a mixture thereof, and
wherein the second element group comprises at least one element selected from the group consisting of: titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), and a mixture thereof.

2. The anode active material for the secondary battery of claim 1, wherein the amount of silicon is in a range of about 60 at % to about 85 at %.

3. The anode active material for the secondary battery of claim 1, wherein the amount of silicon is in a range of about 70 at % to about 85 at %.

4. The anode active material for the secondary battery of claim 1, wherein the first element group comprises both copper and iron.

5. The anode active material for the secondary battery of claim 4, wherein an amount of copper is in a range of about 0 at % to about 15 at % and an amount of iron is in a range of about 0 at % to about 15 at %.

6. The anode active material for the secondary battery of claim 5, wherein the amount of iron to the amount of copper is in a ratio of about 1 to about 1.

7. The anode active material for the secondary battery of claim 1, wherein the amount of the second element group is in a range of about 0 at % to about 10 at %.

8. The anode active material for the secondary battery of claim 1, wherein the second element group comprises both titanium and nickel, and wherein the amount of titanium is in a range of about 0 at % to about 10 at %, and the amount of nickel is in a range of about 0 at % to about 10 at %.

9. The anode active material for the secondary battery of claim 1, wherein the first element group comprises both copper and iron, and the second element group excludes nickel and titanium, and the amount of silicon is in a range of about 60 at % to about 85 at %.

10. The anode active material for the secondary battery of claim 1, wherein the anode active material comprises:
about 18 at % to about 20 at % of the first element group, wherein the first element group comprises equal amounts of copper and iron, and
about 5 at % to about 7 at % of the second element group, wherein the second element group is made up of a single element.

11. A second battery comprising an anode active material, the anode active material comprising:
an amount of a first element group in a range of about 0 at % to about 30 at %;
an amount of a second element group in a range of about 0 at % to about 20 at %; and
an amount of silicon and other unavoidable impurities,
wherein the first element group comprises: copper (Cu), iron (Fe), and a mixture thereof,
wherein the second element group comprises at least one element selected from the group consisting of: titanium (Ti), nickel (Ni), manganese (Mn), aluminum (Al), chromium (Cr), cobalt (Co), zinc (Zn), boron (B), beryllium (Be), molybdenum (Mo), tantalum (Ta), sodium (Na), strontium (Sr), phosphorous (P), and a mixture thereof,
wherein the anode active material comprises a silicon single phase and a silicon-metal alloy phase distributed around the silicon single phase.
